(19) United States
(12) Patent Application Publication
(10) Pub. No.: US 2019/0204172 A1
(43) Pub. Date: Jul. 4, 2019

(54) Pressure Sensor With Stepped Edge and Method of Manufacturing

(71) Applicant: All Sensors Corporation, Morgan Hill, CA (US)

(72) Inventors: Dennis Dauenhauer, Morgan Hill, CA (US); Fred W. Adamic, JR., Aptos, CA (US)

(21) Appl. No.: 15/860,551

(22) Filed: Jan. 2, 2018

(51) Int. Cl. G01L 9/00

(52) U.S. Cl. CPC G01L 9/0054

(57) ABSTRACT

A square-shaped pressure sensor in which the four sides of the sensor have “stepped edge” features. The “stepped edge” features are formed using deep reactive ion etch (DRIE) techniques. The sensor comprises of a first side, a second side, a third side, and a fourth side, and a diaphragm positioned between the four sides. The first side has an outside face comprised of a first ledge and a second ledge; the second side has an outside face comprised of a third ledge and a fourth ledge, the third side has an outside face comprised of a fifth to ledge and a sixth ledge, and the fourth side has an outside face comprised of a seventh ledge and an eighth ledge. The eight ledges are the “stepped edge” features of the sensor.

### BACKGROUND OF THE INVENTION

Piezoresistive silicon pressure sensors are well known in the art. A typical sensor is generally a microelectromechanical system (MEMS), comprised of a piezoresistive substrate, such as silicon, and formed into a sensor having a thin diaphragm comprised of the piezoresistive material. A plurality of resistors (typically four), are formed on the diaphragm using known techniques, such as diffusion, ion implantation, or thin film deposition. If pressure is applied to the diaphragm of the sensor, the resistance changes differently in the radial and transverse directions on the diaphragm. Some piezoresistive sensors use all radial or all transverse oriented resistors. The direction of resistance change depends on where the resistors are located on the diaphragm.

Typically, the resistors are connected in a Wheatstone bridge configuration, and the output of the system is directly proportional to the applied pressure. The sensor is usually positioned inside a package that allows a fluid (usually a gas) whose pressure is to be measured, to contact the diaphragm of the sensor. U.S. Pat. No. 6,023,978, issued Feb. 15, 2000, which is incorporated herein by reference, illustrates some Wheatstone bridge configurations of the resistors, as well as some package configurations for introducing the fluid to the sensor.

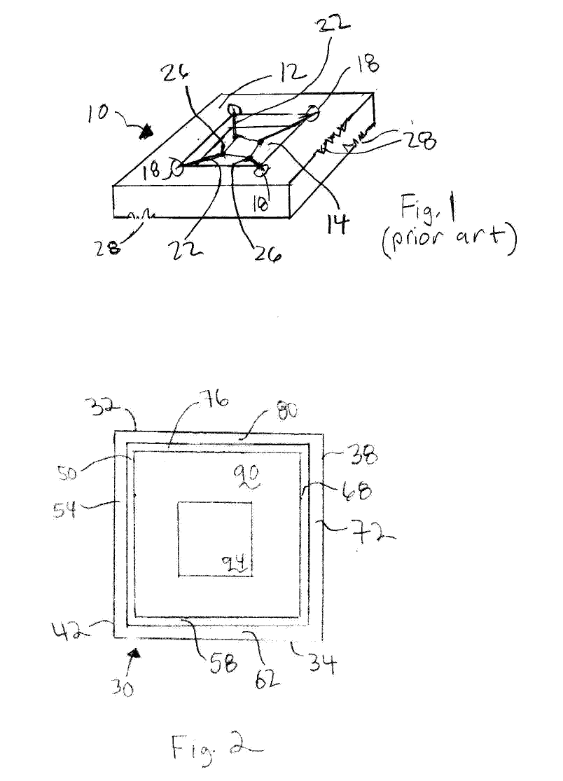

FIG. 1 illustrates a prior art piezoresistive pressure sensor 10 comprised of substrate body 12, a diaphragm 14, bond pads 18, lead lines 22 and resistors 26, where the resistors 26 would typically be connected in a Wheatstone bridge configuration. Several non-electrical problems arise in the manufacturing of these sensors. Specifically, when separating the sensor dies on the wafer, the die yield is usually reduced because of chipping by the saw or laser used to separate the dies. A chipped region 28 is indicated in FIG. 1, but the chipping can occur along the entire length of a side of the die, and can occur on all the sides of the die. Additionally, the bottom edges of the dies have limited surface area which makes bonding the die to another object, such as a ceramic substrate or a printed circuit board difficult. An improved sensor design and manufacturing process is needed to address these problems.

### SUMMARY OF THE INVENTION

Briefly, the pressure sensor of the present invention is a square-shaped sensor in which the four sides of the sensor have “stepped edge” features. The sensor comprises a first side, a second side, a third side, and a fourth side, and a diaphragm positioned between the four sides. The first side has an outside face comprised of a first ledge and a second ledge; the second side has an outside face comprised of a third ledge and a fourth ledge, with the second side being perpendicular to the first side. The third side has an outside face comprised of a fifth ledge and a sixth ledge, with the third side being parallel to the first side and perpendicular to the second side; and the fourth side has an outside face comprised of a seventh ledge and an eighth ledge, with the fourth side being parallel to the second side. The eight ledges are the “stepped edge” features of the sensor.

The pressure sensor is made by forming a sensor body comprised of the first, second, third, and fourth sides, on a wafer comprised of a semiconductor material. The first ledge is formed on the first side, using a first DRIE process, and the first ledge has a height “h” that extends from the front side of the wafer straight downward towards the back side of the wafer, with the first ledge extending along the whole length of the first side.

The second ledge is partially formed on the first side by using a second DRIE process to form a first channel along the first side that extends from the back side of the wafer straight upwards toward the front side of the wafer, the first channel having a height “e” and a width “d,” with the height “e” being less than the width “z” of the wafer. The formation of the second ledge is completed by forming a second channel that extends from the first ledge downward until it intersects the first channel, with the second channel having a width “m” that is greater than the width “d” of the first channel. The second ledge has the height “e” of the first channel, and the second ledge extends along the whole length of the first side.

The third through eighth ledges are formed in the same manner that the first and second ledges were formed, with all the ledges being formed during the same sequence of manufacturing events.

BRIEF DESCRIPTION OF THE SEVERAL VIEWS OF THE DRAWINGS

FIG. 1 illustrates a pressure sensor 10 according to the prior art;

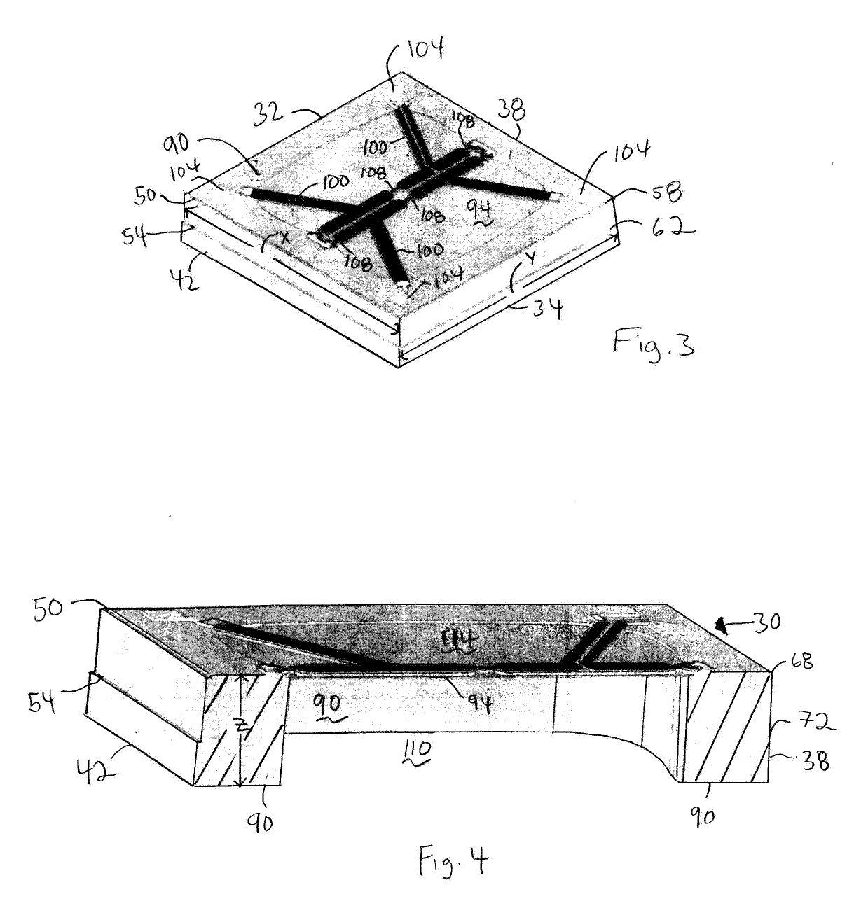

FIG. 2 is a top schematic view of a die according to the present invention;

FIG. 3 is an isometric view of a pressure sensor according to the present invention;

FIG. 4 is cross-sectional view of the pressure sensor of FIG. 3;

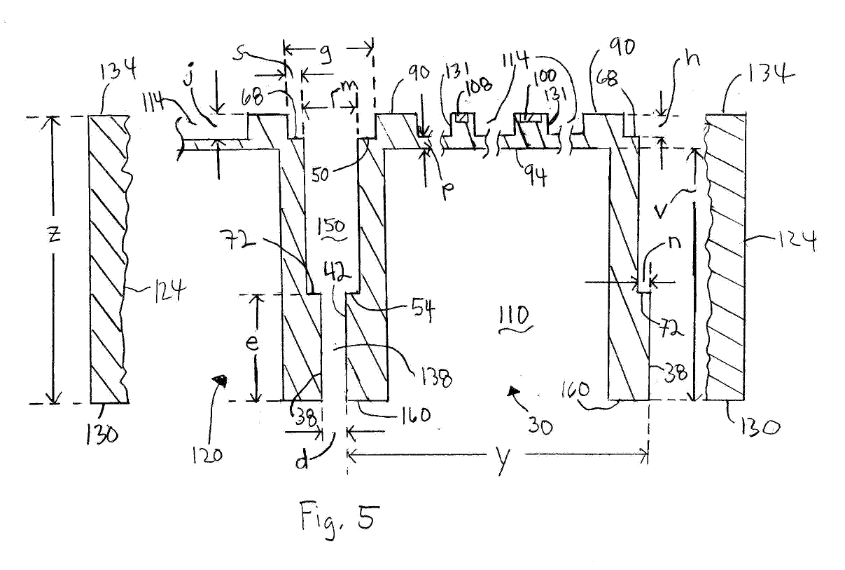

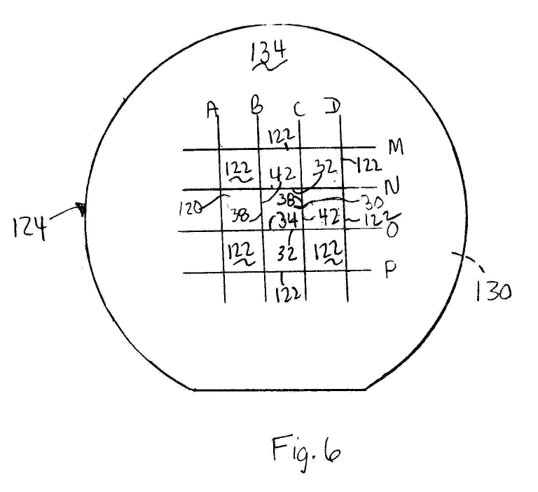

FIG. 5 is a schematic cross-sectional view of the pressure sensor according to the present invention; and

FIG. 6 is a schematic top view of a wafer illustrating the manufacturing method according to the present invention.

### DETAILED DESCRIPTION OF THE INVENTION

FIG. 2 illustrates a die 30 according to the present invention. The die is rectangular (preferably square) and comprises an upper side 32, a lower side 34, a right side 38, and a left side 42. Each side includes a first ledge and a second ledge formed on an outside surface of the die that extends along the length of the given side. Specifically, the left side 42 comprises a left first ledge 50 and a left side second ledge 54 formed on an outside surface of the die 30. The right side 38 comprises a right first ledge 68 and a right side second ledge 72 formed on an outside surface of the die 30. The upper side 32 comprises an upper side first ledge 76 and an upper side second ledge 80. The lower side 34 comprises a lower side first ledge 58 and a lower side second ledge 62. The sides 32, 34, 38, and 42 are said to be “stepped edges” because the presence of the first and second ledges give the sides a step-like appearance on the outside surfaces of the die 30.

The die 30 could be any type of device formed on a semiconductor wafer using semiconductor device manufacturing techniques, such as photolithography and chemical processing. Such devices include integrated circuits and microelectromechanical system (MEMS) devices. However, in the preferred embodiment, the die 30 is a MEMS device, and more specifically, a pressure sensor that uses a thin silicon diaphragm to sense pressure changes. Therefore, in this application, the die 30 will generally be described as a pressure sensor, with the understanding that it could also be other types of devices. FIG. 2 illustrates that when the die 30 is a pressure sensor, it also includes a body 90 and a diaphragm 94.

FIG. 3 illustrates a plurality of lead lines (electrical leads) 100 positioned over the diaphragm 94. The lead lines 100 terminate in a plurality of bond pads 104. The lead lines 100 transmit voltage signals from a plurality of resistors 108 embedded in the diaphragm 94, to a calibration circuit (not shown) that generates a pressure reading. The calibration circuit makes the output voltage proportional to pressure and independent of temperature. In the preferred embodiment illustrated in FIGS. 3 and 4, the resistors 108 are four radial resistors oriented perpendicular to the stress gradient. FIG. 3 also illustrates that the left side 42 has a length “x,” and the lower side 34 has a length “y.” The left side first ledge 50 and the left side second ledge extend along the length of the side 42, and have the length “x.” The lower side first ledge 58 and the lower side second ledge 62 extend along the length of the side 34, and have the length “y.” Similarly, the right side 38 has the length “x,” as do the right side first ledge 68 and the right side second ledge 72. And the top side 32 has the length “y,” as do the top side first ledge 76 and the top side second ledge 80. In the preferred embodiment, the lengths “x” and “y” are equal (x=y), so that the die 30 is square in shape. The square (or rectangular) shape of the die 30 means that the upper side 32 runs parallel to the lower side 34, and that the right side 38 and a left side 42 are parallel to each other, but perpendicular to the sides 32 and 34.

FIG. 4 illustrates that a cavity 110 is positioned underneath the diaphragm 94 and is bounded by the base 90. The cavity 110 is a hollow space formed in the base 90 with a thin strip silicon being left over the top of the cavity 110 to form the diaphragm 94. Above the diaphragm 94 (i.e., on the opposite side of the diaphragm 94 from the cavity 110), is a front cavity 114. The front cavity 114 is much shallower than the cavity 110, and the base 90 has a height “z” extending from the bottom to the top of the die 30. The height “z” is the same as the thickness of the wafer 124 shown in FIG. 5.

FIG. 5 illustrates how the sides 32, 34, 38, and 42 are formed to have the stepped edge features. FIG. 5 shows the die 30 and an adjacent die 120 on the left side of the die 30. A plurality of identical dies 122 (shown in FIG. 6), including the dies 30 and 120, are all formed on a semiconductor wafer 124, and each of the dies on the wafer 124 have the sides 32, 34, 38, and 42. The wafer 124 has a back side 130, a front side 134, and the thickness “z.” In the preferred embodiment, the wafer 124 is comprised of silicon, but other piezoresistive semiconducting materials, such as silicon carbide, could be used.

In FIG. 5, for simplification, the wafer 124 is illustrated as being a uniform semiconductor structure. In the preferred embodiment, the wafer 124 is actually a silicon-on-insulator (SOI) structure comprised of “handle” silicon on the bottom, with a layer of n-type silicon on top and an oxide layer sandwiched between the handle silicon and the layer of n-type silicon. The body 90 includes all of the layers of the SOI structure, including the handle silicon, the n-type silicon, and the oxide layer.

In FIG. 5, for purposes of illustration, the formations of side 42 on the die 30, and side 38 on the adjacent die 120, are discussed first. But in the preferred embodiment, the sides 32, 34, 38, and 42 on the die 30 (and on all the other dies 122 on the wafer 124) are all formed together using the same sequence of manufacturing steps. In the preferred embodiment, the side 42 on a first die is partially formed in conjunction with the side 38 on a second die which is adjacent (next to) the first die on the wafer. The formation of the sides 42 and 38 is completed when the dies are finally separated from the wafer in a scribe process. Similarly, the side 32 on the first die is partially formed in conjunction with the side 34 on a third die which is adjacent (next to) the first die on the wafer, and the formation of the sides 32 and 34 is completed when dies are finally separated from the wafer.

Before the stepped edge features are formed, the electrical components of the sensors are formed on the front sides 134 of the plurality of dies (or dice), including the dies 30 and 120. The electrical components include the lead lines 100, the resistors 108, the electrical contacts (not shown), and the bond pads 104. These electrical components are formed using techniques well-known in the field of semiconductor manufacturing and discussed further below. As shown in FIG. 5, the lead lines 100 and resistors 108 are formed on regions 131 of the body 90 that have not been etched away when the front cavity 114 is formed.

After the electrical components have been formed, the formation of the sides 42 and 38, on the dies 30 and 120, respectively, is started. To do this, the ledges 50 and 68 are formed on the dies 30 and 120, by forming a rectangular depression in the front side 134 having a width “g” and a depth “h.” This rectangular depression extends along the entire length of the side 42 and has the length “x” (shown in FIG. 3) to give the ledges 50 and 68 the proper lengths. The full shape of the ledges 50 and 68 is not completed until a channel 150 is formed later, to separate the dies 30 and 120, as is discussed below. In the preferred embodiment, the rectangular depression that forms the ledges 50 and 68 is made using a first deep reactive ion etch (DRIE) process. Preferably, the front cavity 114 is formed simultaneously with the ledges 50 and 68 using the first DRIE process, and the front cavity 114 has a depth “j” that is the same as the depth “h.” The ledge 68 has the width “s,” and similarly, each of the ledges 50, 58, and 76, also have the width “s.” Because the wafer 124 is an SOI structure, the first DRIE process is etching down through a layer of n-type silicon on the front side 134, as will be explained later.

The sides 32 and 34 are formed at the same time as the sides 38 and 42, using the same technique described above for partially forming the sides 38 and 42. Specifically, on the front side 134, the ledges 76 and 58 are formed on adjacent dies by forming a rectangular depression in the front side 134 having the width “g” and the depth “h.” This rectangular depression extends along the entire length of the side 34 and has the length “y” to give the ledges 76 and 58 the proper lengths. The full shape of the ledges 76 and 58 is not completed until a channel 150 is formed later, to separate the adjacent dies, as is discussed below. In the preferred embodiment, the rectangular depression that partially forms the ledges 76 and 58 is made using the same first DRIE process used to partially form the ledges 50 and 68, and the front cavity 114.

After the ledges 50, 68, 76, and 58 have been formed on all the dies on the wafer 124, processing of the back side 130 is started. Starting from the back side 130, a channel 138 is formed between the dies 30 and 120, for example, to partially form the sides 42 and 38, respectively. The channel 138 has a width “d” and a height “e.” The height “e” extends upward from the backside 130 toward the front side 134 that is perpendicular to the back side 130. In the preferred embodiment, the channel 138 is formed using a second deep reactive ion etch (DRIE) process. In the preferred embodiment, the cavity 110 is formed simultaneously with channel 138 using the same DRIE process. The cavity 110 has a height “v” that extends from the backside 130 upwards, but stops before reaching the front cavity 114, thus leaving a thin strip of silicon that will form the diaphragm 94.

Because the wafer 124 is an SOI structure, the second DRIE process etches up through the handle silicon until the oxide layer is encountered, as will be explained later. The oxide layer is then etched away in a separate process, thus leaving the diaphragm 94 as a thin strip of n-type silicon having a width “p.” In the second DRIE process, the width “d” required to yield a desired height “e” of the channel 138 must be determined empirically, because the trench aspect ratio (depth/width) for a DRIE process is a function of the width of the trench.

The sides 32 and 34 are formed at the same time as the sides 38 and 42, using the same technique described above for partially forming the sides 38 and 42. Specifically starting from the back side 130, the channel 138 is formed between two adjacent dies, to partially form the sides 32 and 34. The channel 138 has the width “d” and the height “e.” The height “e” extends upward from the backside 130 toward the front side 134 that is perpendicular to the back side 130. In the preferred embodiment, the channel 138 between the sides 32 and 34 is formed using the same second DRIE process used to partially form the sides 38 and 42, and the cavity 110.

Finally, the channel 150 (shown in FIG. 5) is formed to separate the sides 38 and 42.

The channel 150 starts from the front side 134 and extends downward until the channel 138 is encountered. The channel 150 has a width “m” that is greater than the width “d,” and which is centered between the dies 30 and 120, so that the ledges 54 and 72 are formed on the dies 30 and 120, respectively. Each of the ledges 54 and 72 has a width “n.” Similarly, the ledges 62 and 80 each have the width “n.”

In the preferred embodiment, a laser or a dicing saw is used to form the channel 150 by removing semiconductor material from the channel 150 by the cutting action of the laser or dicing saw. Similarly, a separate channel 150 is used to separate the sides 32 and 34 on adjacent dies, and form the ledges 80 and 62, respectively, using the same dicing technique used to form the ledges 54 and 72 shown in FIG. 5. In an alternative embodiment, a dicing method, known as stealth dicing, can be used to separate the sides 38 and 42 (and the sides 32 and 34). Stealth dicing introduces defect regions into the wafer along a line where separation is desired, such as with a pulsed laser, and then fractures the wafer along the line of separation to achieve separation of the dies (e.g., down the middle of channel 150). Stealth dicing would essentially provide a channel 150 that is zero microns wide, so that the width “m” would be less than the width “d,” thereby inverting the shape of the ledges 54 and 72 (and ledges 62 and 80).

FIG. 6 illustrates the plurality of identical dies 122, including the dies 30 and 120, formed on the semiconductor wafer 124. Each of the dies 122 have the sides 32, 34, 38, and 42. In practice, the number of dies on the wafer would probably be greater than is shown in FIG. 6, to fill more or most of the surface area of the wafer, and the positions and features of the individual dies are determined by one or more photomasks in the photolithographic process. FIG. 6 is a top view showing the front side 134 of the wafer 124. The back side 130 is underneath the plane of the page containing FIG. 6.

A set of vertical axes A, B, C and D, and a set of horizontal axes M, N, O and P, are shown in FIG. 6 to illustrate how the sides 32, 34, 38, and 42 are formed on all the dies simultaneously. Starting on the front side 134, the resistors 108, the bond pads 104, the contacts, and the lead lines 100 (shown in FIG. 3) are formed on each die in the plurality of dies 122 on the wafer 124.

Next, on the front side 134, the ledges 50 and 68 are formed simultaneously by forming the rectangular depression having the width “g” and the depth “h” along the full length of the vertical axes A, B, C and D. At the same time, the ledges 58 and 80 are formed simultaneously by forming the rectangular depression having the width “g” and the depth “h” along the full length of the vertical axes M, N, O and P. As noted previously, preferably, the front cavity 114 is formed simultaneously with the ledges 50 and 68 using the first DRIE process.

Then, from the back side 130, the channel 138 (shown in FIG. 5) is formed simultaneously on the sides 32, 34, 38, and 42 of each die in the plurality of dies on the wafer 124. In the preferred embodiment, this is done by performing the second DRIE process along the vertical axes A, B, C and D, and along all of the horizontal axes M, N, O and P, so that the channel 138 has the width “d” and the height “e” on the back side 130 along all of the vertical axes A, B, C and D, and along all of the horizontal axes M, N, O and P. As noted previously, preferably the cavity 110 (shown in FIG. 5) is formed simultaneously with channels 138 on each die in the plurality of dies using the same second DRIE process.

Finally, on the front side 134, the channel 150 (shown in FIG. 5) is formed along the full length of the vertical axes A, B, C and D, and along the full length of all the vertical axes M, N, O and P, to completely separate the sides 38 and 42 on adjacent dies, and to completely separate the sides 32 and 34 on adjacent dies, for each of the plurality of dies 122 on the wafer 124, thereby separating the plurality of dies 122 from each other.

Referring to FIGS. 2-5, in the preferred embodiment, the first ledge 50 comprises the bottom section of an L-shaped notch formed on a side of the die 30. The first ledge 50 forms an approximately right angle with a vertical wall of the die 30, and the first ledge 50 has the width “s” where there is no semiconductor material above the ledge 50 along the width “s” and there is semiconductor material below the ledge 50 along the width “s.”

Similarly, the ledges 76, 68, 58, 54, 80, 72, and 62, each comprise the bottom section of an L-shaped notch formed on a side of the die 30. Each ledge forms an approximately right angle with a vertical wall of the die 30, and each ledge has a width where there is no semiconductor material above the ledge along the width, and there is semiconductor material below the ledge along the width.

More generally, the ledges 50, 76, 68, 58, 54, 80, 72, and 62, each comprise a length of semiconductor material that runs generally in the same direction (i.e. parallel to) as the top plane of the die, with semiconductor material underneath the ledge and open space (i.e. no semiconductor material) above the ledge. A vertical wall of the semiconductor material abuts and makes a roughly 90-degree angle with the ledge. The expression “generally in the same direction” means that the surface of the ledge is oriented parallel to the top plane of the die, within the accuracy allowed by standard semiconductor manufacturing techniques, including DRIE processing.

In a preferred embodiment, the die 30 comprises the sensor body 90 comprised of a semiconductor material and having the first side 32, the second side 38, the third side 34, and the fourth side 42, with the first side having an outside surface comprised of the first ledge 76 and the second ledge 80. The second side has an outside surface comprised of the third ledge 68 and the fourth ledge 72, with the second side 38 being perpendicular to the first side 32. The third side 34 has an outside surface comprised of the fifth ledge 58 and the sixth ledge 62, with the third side 34 being parallel to the first side 32 and perpendicular to the second side 38. The fourth side 42 has an outside surface comprised of the seventh ledge 50 and the eighth ledge 54, with the fourth side being parallel to the second side 38. The diaphragm 94 is positioned between the four sides 32, 38, 34, and 42.

The die 30 has several advantages over the prior art. First, the die attach areas 160 (shown in FIG. 5) increase the surface area for the die attach process. This improves the die attach process and seal where the die/sensor is attached to a substrate, such as a ceramic substrate or a printed circuit (PC) board. Typically, this attachment is accomplished using an RTV type of adhesive (i.e., a room temperature vulcanizing silicone adhesive), but other adhesives could be used. The surface area of the die attach areas 160 is increased because the width of the area 160 is greater than it would be if the channel 150 extended all of the way down to the back side 130, as is common in the prior art.

Second, the presence of the ledges 50, 68, 76, and 58 on the die 30 reduces the amount chipping along the front side 134 that occurs during the die separation process with the saw or laser scribe. The presence of the channel 138 reduces the amount chipping along the back side 130 that would occur during the die separation process, because the saw or laser scribe does not cut down to the back side 130.

Third, the stepped edge features of the sides 32, 34, 38, and 42, are thought to reduce parasitic offset effects (i.e., factors that cause extraneous pressure readings by the pressure sensor). This is probably because the increased width of the die attach region 160 provides additional strength to the die in resisting bending forces which the die senses as pressure. Also, the smooth DRIE sidewalls which prevent chipping along the front and back side edges of the die eliminate inward directed fractures which may be sensed by the resistors 108 as pressure.

Some of the conventional semiconductor manufacturing techniques and representative dimensions used in the present invention are as follows:

1. Deep Reactive Ion Etch (DRIE) Technology

In a preferred embodiment, the DRIE process is a Bosch-type process that uses alternating plasma etch steps and sidewall passivation steps to accomplish an anisotropic etch. Preferably sulfur hexafluoride (SF₆) is the ion source for etching, and octafluorocyclobutane (C₄F₈) is the passivation agent, but other chemicals can be used. The basic process steps involved in the DRIE etch include applying photoresist to the wafer, exposure through a photomask, developing the pattern, performing an oxide etch, performing the DRIE etch, and cleaning away the photoresist.

The DRIE process is used to form structures with straight, relatively smooth sides and a flat bottom that forms a right angle to the sides. In the present invention, structures of this type are the ledges 50, 58, 68, and 76; the channel 138; and the cavities 110 and 114. The use of a DRIE process for forming features in semiconductor and/or MEMS devices is well-known and is described in publications such as U.S. Pat. No. 5,501,893; U.S. Pat. No. 6,127,273; and European patent application EP 2,105,952A2, all of which are incorporated by reference herein.

2. Electrical Components

The lead lines are formed by photoresist masking, ion implantation, resist clean, and high temperature diffusion.

The piezoresistors are formed in the diaphragm and consist of simple two contact diffused n- or p-wells within a p- or n-piezoresistive substrate. In the preferred embodiment (and in most or all known silicon piezoresistive sensors), p-type resistors are diffused into an n-type substrate. The resistors are formed by using a photoresist mask to isolate the desired location, ion implantation to form the resistors, resist clean, and high temperature diffusion.

The bond pads are formed by aluminum metal deposition, photoresist mask, metal etching, and resist clean. Preferably, the resistors and lead lines are covered with an approximately 0.1 micron surface oxide layer for insulation, and to protect the p-n surface junctions from contamination.

As noted previously, in the preferred embodiment the wafer 124 is a silicon-on-insulator (SOI) structure. The SOI structure is comprised of approximately 350 microns of “handle” silicon on the bottom (including the back side 130), with an approximately thirteen micron layer of n-type silicon on top (forming the front side 134), and an approximately one micron oxide layer (silicon dioxide) sandwiched between the handle silicon and the layer of n-type silicon. The oxide layer is sometimes referred to as a buried oxide (BOX) layer.

The front cavity 114 is formed by the first DRIE process etching down approximately eight microns through the layer of n-type silicon on the front side 134. This leaves a strip of n-type silicon having a width of approximately five microns which will eventually form the diaphragm 94. The second DRIE process etches up through the handle silicon until the BOX layer is encountered, thereby forming the cavity 110. The BOX layer is then etched away in a separate process, such as with hydrofluoric acid (HF), until the n-type silicon layer is reached, thus leaving the diaphragm 94 as a thin strip of n-type silicon having the width “p” over the cavity 110.

3. Dimensions

Some of the dimensions used in the present invention are listed below. These are representative dimensions used in a preferred embodiment, and other dimensions could be used in other embodiments. (One micron equals 1×10⁻⁶ meters).

In FIG. 3, x=2050 microns; y=2050 microns.

In FIGS. 4 and 5, z=364 microns.

In FIG. 5, d=5 microns; e=150 microns; g=100 microns; j and h=8 microns; m=35 microns, n=15 microns; p=5 microns; s=32.5 microns.

Although the present invention has been described in terms of the presently preferred embodiments, it is to be understood that such disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

We claim:

1. A sensor comprising:
a sensor body comprised of a semiconductor material and having a first side, a second side, a third side, and a fourth side;
the first side having an outside surface comprised of a first ledge and a second ledge;
the second side having an outside surface comprised of a third ledge and a fourth ledge, with the second side being perpendicular to the first side;
the third side having an outside surface comprised of a fifth ledge and a sixth ledge, with the third side being parallel to the first side and perpendicular to the second side;
the fourth side having an outside surface comprised of a seventh ledge and an eighth ledge, with the fourth side being parallel to the second side; and
a diaphragm positioned between the four sides.

2. The sensor of claim 1 wherein the first ledge is positioned approximately 8 microns below the top of the front side of the sensor and the second ledge is positioned approximately 150 microns above the bottom of the sensor.

3. The sensor of claim 2 wherein the third ledge is positioned approximately 8 microns below the top of the front side of the sensor and the fourth ledge is positioned approximately 150 microns above the bottom of the sensor.

4. The sensor of claim 1 wherein the semiconductor material comprises silicon.

5. The sensor of claim 1 wherein the sensor body is square in shape.

6. The sensor of claim 1 wherein the first ledge forms an approximately right angle with a vertical wall of the sensor body, and the first ledge has a width “s” where there is no semiconductor material above the first ledge along the width “s,” and there is semiconductor material below the first ledge along the width “s.”

7. A method for making a piezoresistive pressure sensor comprising:
forming a first ledge on a first side of a sensor body, the first ledge having a height “h” that extends from the front side of a wafer straight down towards the back side of the wafer, with the first ledge extending along the whole length of the first side;
forming a first channel along the first side that extends from the back side of the wafer straight upwards toward the front side of the wafer, the first channel having a height “e” and a width “d,” with the height “e” being less than the width of the wafer; and
forming a second ledge on the first side, the second ledge having the height “e” of the first channel, with the second ledge extending along the whole length of the first side.

8. The method of claim 7 wherein the first ledge on the first side is formed using a first DRIE process.

9. The method of claim 7 wherein the first channel is formed using a second DRIE process.

10. The method of claim 7 wherein the second ledge is formed by causing a second channel to be formed, the second channel extending from the first ledge downward until it intersects the first channel, with the second channel having a width “m” that is greater than the width “d” of the first channel.

11. The method of claim 7 wherein a front side cavity is formed in the sensor body at the same time the first ledge is formed.

12. The method of claim 7 wherein a back side cavity is formed in the sensor body at the same time the first channel is formed.

13. The method of claim 7 wherein the wafer is comprised of a semiconductor material.

14. The method of claim 11 further comprising:
forming a third ledge on a second side of the sensor body, the second ledge having the height “h” that extends from the front side of the wafer straight downward towards the back side of the wafer, with the second ledge extending along the whole length of the second side, and wherein the second ledge is formed at the same time the first ledge is formed.
